(19) United States
(12) Patent Application Publication
(10) Pub. No.: US 2005/0207447 A1
(43) Pub. Date: Sep. 22, 2005

(54) IP address duplication monitoring device, IP address duplication monitoring method and IP address duplication monitoring program

(75) Inventors: Atsuji Sekiguchi, Kawasaki (JP); Masataka Sonoda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/132,201

(22) Filed: May 19, 2005

Related U.S. Application Data
(63) Continuation of application No. PCT/JP03/00855, filed on Jan. 29, 2003.

(51) Int. Cl. H04J 3/24

(52) U.S. Cl. 370/475

(57) ABSTRACT

An IP address duplication monitoring device that performs monitoring for IP address duplication of a device to be monitored that is connected through a router and a network, when a LAN is connected with a network outside the LAN through a router provided with an ARP cache in which a set comprising an IP address and a lower layer address which is an address of a lower layer than the IP layer is held for a fixed period, and a device to be monitored, which is a device that provides a service to the network, is present in a LAN, the IP address duplication monitoring device having: a service request issuing section that sends a plurality of service requests to the device to be monitored; a service response analysis section that receives service responses obtained as a result of the service requests; and a monitoring section that generates an instruction for a service request to said service request issuing section at prescribed time intervals, that compares said plurality of service responses obtained from said service response analysis section and that makes a decision as to the existence of IP address duplication based on the results of this comparison.

### TECHNICAL FIELD

The present invention relates to technology for performing operation monitoring of an IP (Internet Protocol) network and fault detection thereof, and in particular relates to an IP address duplication monitoring device that monitors duplicate setting of IP addresses on an IP network, IP address duplication monitoring method and IP address duplication monitoring program.

### BACKGROUND ART

If, in a LAN (local area network) of an IP network, duplicate setting is performed i.e. the same IP address is allocated to a newly installed device as that of an existing device, phenomena occur that present various problems. For example, if the same IP address as the IP address of a Web server is set in another device or a network device, the phenomenon occurs that viewing of the pages of the Web server may become intermittent, depending on the timing of accesses from the end user. Although this phenomenon may be brought about by various other causes, at this point, we shall focus on the problem of IP address duplication.

Conventional monitoring for IP address duplication is performed by installing a monitoring device for IP address duplication monitoring in the same LAN as the device to be monitored. The monitoring device performs monitoring by checking the correspondence relationship between an IP address and an address at a lower layer than the IP address. For example, in the case of Ethernet, the correspondence relationship between the IP address and the MAC (media access control) address is checked. If there are two or more ARP responses to an ARP (Address Resolution Protocol) request in respect of a given IP address, it may be judged that IP address duplication is occurring, and IP address duplication can thus be detected by using the monitoring device to monitor devices that make ARP requests.

However, with the prior art described above, the following problems occur.

Conventionally, it is necessary to install a monitoring device on introduction into each network demarcated by a router, so there were the problems of the need for introduction of a switch hub fitted with a mirror port and/or fitting of a tap, and of temporary stoppage of operation in order to set these up. Also, in the case of a customer network monitoring business, for example the problem of security arises, due to the need to install a monitoring device in the customer network. A further problem that arises is the enormous increase in installation costs and operating costs in a large scale network such as an IDC (Internet Data Center), due to the need to install monitoring devices in each network.

In view of the foregoing problems, an object of the present invention is to provide an IP address duplication monitoring device capable of detecting IP address duplication from a network outside the network demarcated by the router, without installing a monitoring device for IP address duplication monitoring in the network in which the device to be monitored is installed, an IP address duplication monitoring method and IP address duplication monitoring program.

### DISCLOSURE OF THE INVENTION

According to the present invention, there is provided an IP address duplication monitoring device that is capable of communication with a network having a router comprising an ARP cache in which a set comprising an IP address and a lower layer address which is an address of a lower layer than the IP layer is held for a fixed period and that performs monitoring of IP address duplication for a device to be monitored that is connected with the network; further comprising a service request issuing section that sends a plurality of service requests to the device to be monitored; a service response analysis section that receives service responses obtained as a result of the service requests; and a monitoring section that generates an instruction for a service request to the service request issuing section at prescribed time intervals, that compares the plurality of service responses obtained from the service response analysis section and that makes a decision as to the existence of IP address duplication based on the results of this comparison.

With this construction, it is possible to monitor IP address duplication even in remote locations separated by several routers from the device to be monitored. Also, since the service responses of services that are conventionally provided by the device to be monitored are utilized, monitoring can be performed without needing to effect any alteration to the device to be monitored. It should be noted that, in this embodiment, the “router” is the gateway router 3.

Also, an IP address duplication monitoring device according to the present invention is characterized in that the monitoring section generates an instruction for a first service request to the service request issuing section and, after a prescribed time interval, generates an instruction for a second service request, and compares the first service response obtained in respect of the first service request instruction with the second service response obtained in respect of the second service request instruction.

With such a construction, IP address duplication can be detected by comparing the two service responses.

Also, an IP address duplication monitoring device according to the present invention is characterized in that the lower layer address is a MAC address.

Also, an IP address duplication monitoring device according to the present invention is characterized in that the monitoring section generates an instruction for a service request in respect of a service that returns a service response that is specific to the device to be monitored.

With such a construction, by selecting a service that returns a characteristic service response, of the services provided by the device to be monitored, it is possible to judge whether the service response is from the device to be monitored or is a service response from another device in the same network.

Also, an IP address duplication monitoring device according to the present invention is characterized in that the service that returns a service response that is specific to the device to be monitored is any of telnet that returns a service response including the OS version or kernel version, ftp, pop, or dns that returns a service response including FQDN, a service or application that is unique to the device to be monitored and that is not provided by the other devices in the LAN, or www top page.

With such a construction, by selecting a service that returns a characteristic service response, of the services provided by the device to be monitored, it is possible to judge whether the service response is from the device to be monitored or is a service response from another device in the same network.

Also, an IP address duplication monitoring device according to the present invention is characterized in that the monitoring section generates an instruction for the first service request after confirming that the ARP cache of the router has been cleared.

With such a construction, it is possible to detect IP address duplication by the possibility of routing of two service requests to different devices in the case of IP address duplication, in accordance with the ARP response obtained by an ARP request after clearing of the ARP cache.

Also, an IP address duplication monitoring device according to the present invention is characterized in that the time interval is set in a range whose minimum value is the time period for the router to receive the first service request, send an ARP request and, receive the ARP response, to perform routing of the service request, and whose maximum value is the time period required for clearing of the ARP cache by the router.

With such a construction, it is possible to detect IP address duplication by the possibility of routing of two service requests to different devices in the case of IP address duplication, in accordance with the ARP response obtained by an ARP request after clearing of the ARP cache.

Also, an IP address duplication monitoring device according to the present invention is characterized in that the monitoring section judges that no IP address duplication exists if the first service response is a normal service response and the second service response is a normal service response and the contents of the first service response and the second service response are the same.

With this construction, it is possible to identify the case that there is no IP address duplication by comparing the two service responses.

Also, an IP address duplication monitoring device according to the present invention is characterized in that, if the device to be monitored provides a plurality of services, the monitoring section generates an instruction for the first service request corresponding to each of the plurality of services and generates an instruction for the second service request corresponding to each of the plurality of services, performs a comparison of the service response obtained for each service and makes a decision as to the existence of IP address duplication based on the results of this comparison.

With this construction, the accuracy of detection of IP address duplication can be improved, since more service responses are obtained.

Also, an IP address duplication monitoring device according to the present invention is characterized in that the monitoring section repeats a set of the instruction to request a first service and the instruction to request a second service a plurality of times, compares the plurality of service responses obtained and makes a decision as to the existence of IP address duplication based on the results of this comparison.

With this construction, the accuracy of detection of IP address duplication can be improved, since more service responses are obtained.

Also, an IP address duplication monitoring device according to the present invention is characterized in that, if the device to be monitored provides a plurality of services, the monitoring section generates an instruction for the first service request corresponding to each of the plurality of services and generates an instruction for the second service request corresponding to each of the plurality of services, and further repeats a set of the instruction to request a first service and the instruction to request a second service a plurality of times, performs a comparison of the service response obtained for each service and makes a decision as to the existence of IP address duplication based on the results of this comparison.

With this construction, the accuracy of detection of IP address duplication can be improved, since more service responses are obtained.

Also, according to the present invention, there is provided an IP address duplication monitoring method of performing monitoring for IP address duplication from outside of a network for a device to be monitored that is connected with the network having a router comprising an ARP cache in which a set comprising an IP address and a lower layer address which is an address of a lower layer than the IP layer is held for a fixed period, comprising giving an instruction for a service request to the service request issuing section at prescribed time intervals; sending a service request to the device to be monitored in accordance with the service request instructions; receiving the service response obtained as a result of the service requests; and comparing the plurality of service responses received and making a decision as to the existence of IP address duplication based on the results of this comparison.

With this construction, it is possible to monitor IP address duplication even in remote locations separated by several routers from the device to be monitored. Also, since the service responses of services that are conventionally provided by the device to be monitored are utilized, monitoring can be performed without needing to effect any alteration to the device to be monitored.

Also, according to the present invention, there is provided an IP address duplication monitoring program which is stored on a computer readable medium, for causing a computer to execute monitoring of IP address duplication from outside of a network, for a device to be monitored that is connected with a network having a router comprising an ARP cache in which a set comprising an IP address and a lower layer address which is an address of a lower layer than the IP layer is held for a fixed period, the program being characterized in that it causes the computer to execute: giving an instruction for a service request to the service request issuing section at prescribed time intervals; sending a service request to the device to be monitored in accordance with the service request instructions; receiving the service response obtained as a result of the service requests; and comparing the plurality of service responses received and making a decision as to the existence of IP address duplication based on the results of this comparison.

With this construction, it is possible to monitor IP address duplication even in remote locations separated by several routers from the device to be monitored. Also, since the service responses of services that are conventionally provided by the device to be monitored are utilized, monitoring can be performed without needing to effect any alteration to the device to be monitored.

According to the present invention the computer readable medium may be a portable storage medium such as a CD-ROM or a floppy disk, DVD disc, magneto-optical disc, IC card, a database holding a computer program, or another computer and its database or a transfer medium on a communications circuit.

### BRIEF DESCRIPTION OF-THE DRAWINGS

FIG. 1 is a block diagram showing an example of a system layout in which an IP address duplication monitoring device according to the present embodiment is installed;

FIG. 2 is a functional block diagram showing an example layout of an IP address duplication monitoring device according to the present embodiment;

FIG. 3 is a block diagram showing an example layout of a gateway router;

FIG. 4 is a flow chart showing an example of the operation of an IP address duplication monitoring device according to the present embodiment;

FIG. 5 is a table showing an example of monitoring decision results; and

FIG. 6 is a view showing an example of normal service response for each service.

### DESCRIPTION OF THE PREFERRED EMBODIMENTS

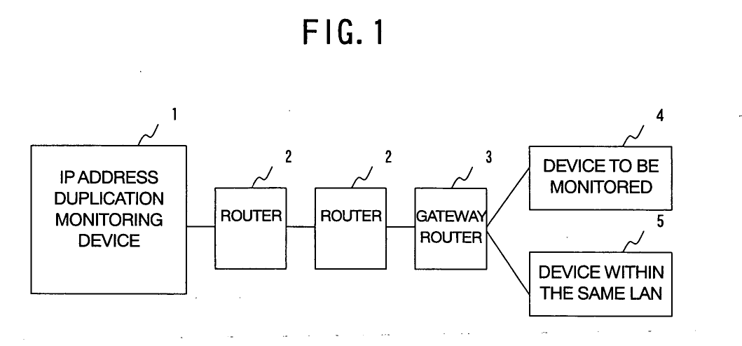

An embodiment of the present invention is described below with reference to the drawings. FIG. 1 is a block diagram showing an example of a system layout in which an IP address duplication monitoring device according to the present embodiment is installed. As shown in FIG. 1, the IP address duplication monitoring device 1 is connected with the device 4 to be monitored through for example a plurality of routers 2 and a gateway router 3. The gateway router 3 is the router, of the routers on the path from the IP address duplication monitoring device 1 to the device 4 to be monitored, that is positioned immediately upstream of the device 4 to be monitored. Also, devices 5 in the same LAN, in addition to the device 4 to be monitored, are connected with the gateway router 3.

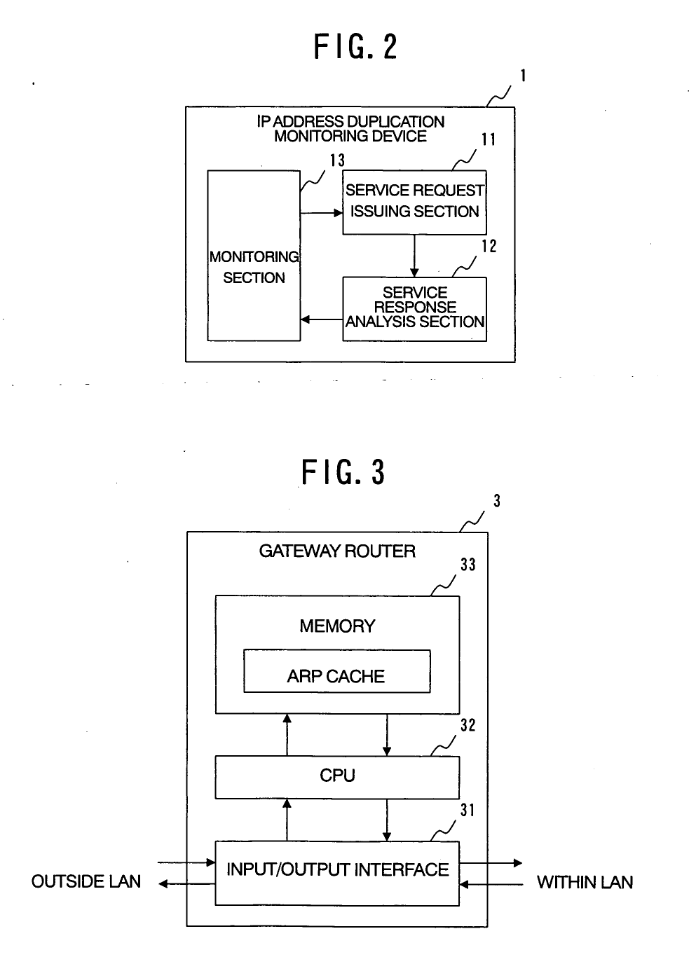

Next, the IP address duplication monitoring device 1 according to the present embodiment will be described. FIG. 2 is a functional block diagram showing an example layout of an IP address duplication monitoring device according to the present embodiment. As shown in FIG. 2, the IP address duplication monitoring device 1 comprises a service request issuing section 11, a service response analysis section 12 and a monitoring section 13.

Next, the operation of the IP address duplication monitoring device 1 will be described. In the monitoring section 13 there are registered beforehand the IP address of the device 4 to be monitored and the services that are provided by the device 4 to be monitored. The monitoring section 13 twice generates an instruction for a service request with the same content in respect of the service request issuing section 11. The first service request and the second service requests are spaced by a prescribed time interval.

In accordance with the instruction from the monitoring section 13, the service request issuing section 11 connects with the port of the device 4 to be monitored that provides the service and sends a service request generated with the protocol of this service to the IP address of the device 4 to be monitored. In the present embodiment, the service that is provided by the device 4 to be monitored is assumed to be HTTP (Hypertext Transfer Protocol) and connection is effected to the HTTP port (normally TCP No. 80). Also, the service request issuing section 11 outputs the content of the service request that was transmitted, to the service response analysis section 12.

The service response analysis section 12 receives the response in respect of the service request from the service request issuing section 11 and outputs the received response to the monitoring section 13. A first response is received in respect of the first service request and a second response is received in respect of the second service request.

The monitoring section 13 ascertains the probability of IP address duplication by comparing the two service responses. The above operations are repeated a number of times equal to the number of all of the IP addresses that are to be monitored and when they are completed are repeated after an appropriate time interval.

Next, the gateway router 3 will be described. The gateway router 3 used in this embodiment implements ARP (RFC 826) and satisfies the “MUST” condition of “2.3.2.1” and the “SHOULD” condition of “2.3.2.2” in the quoted text of RFC 1122 indicated below.

(Quoted Text of RFC 1122)

2.3.2.1 ARP Cache Validation

An implementation of the Address Resolution Protocol (ARP) [LINK: 2] MUST provide a mechanism to flush out of date cache entries.

2.3.2.2 ARP Packet Queue

The link layer SHOULD save (rather than discard) at least one (the latest) packet of each set of packets destined to the same unresolved IP address, and transmit the saved packet when the address has been resolved.

FIG. 3 is a block diagram showing a layout example of a gateway router. As shown in FIG. 3, the gateway router 3 comprises an input/output interface 31, a CPU 32 and a memory 33. The memory 33 comprises an ARP cache. The ARP cache comprises an ARP cache table constituting a table that stores a set of IP address and MAC address. It should be noted that, in this embodiment, it is necessary to clear the ARP cache beforehand prior to performing monitoring for IP address duplication. Regarding the method of clearing the ARP cache, a technique such as an operation using for example Telnet may be employed, but there is no restriction to this.

Next, the operation of the gateway router 3 will be described. This gateway router sends and receives the service requests and service responses and ARP requests and ARP responses through an input/output interface 31. When the gateway router 3 receives a service request from the IP address duplication monitoring device 1, its CPU 32 retrieves the IP address indicated by the service request from its ARP cache table.

If the IP address indicated by the service request is present in the ARP cache table, the CPU 32 routes the service request to the MAC address corresponding to this IP address.

On the other hand, if the IP address indicated by the service request is not present in the ARP cache table, the CPU 32 broadcasts an ARP request for the IP address indicated by the service request. When the gateway router 3 receives an ARP response corresponding to the ARP request, its CPU 32 writes the MAC address obtained by the ARP response in its ARP cache table in a set together with the IP address indicated by the service request and routes the service request to this MAC address.

Also, when the gateway router 3 receives a service response from for example the device 4 to be monitored, its CPU 32 sends the service response to the IP address duplication monitoring device 1 that transmitted the service request. The foregoing represents the operation of the gateway router 3.

The operation of routing service requests that is actually performed by the gateway router 3 will now be described in detail with reference to FIG. 1. For convenience in description, the IP address of the device 4 to be monitored will be denoted by A, the MAC address of the device 4 to be monitored will be denoted by X and the MAC address of a device 5 in the same LAN will be denoted by Y.

First of all, the case will be described in which no IP address duplication was set up. Since the ARP cache of the gateway router 3 that received the first service request to the device 4 to be monitored from the IP address duplication monitoring device 1 was cleared, the ARP request in respect of the IP address A is broadcast. The device 4 to be monitored that has received the ARP request sends its own MAC address X to the gateway router 3 as an ARP response.

When the gateway router 3 has received the ARP response from the device 4 to be monitored, its stores the IP address A and the MAC address X as a set in its ARP cache table, and routes the first service request to the device 4 to be monitored having the MAC address X. When the device 4 to be monitored receives this first service request, it sends a service response in respect of the first service request to the IP address duplication monitoring device 1.

Next, when the gateway router 3 receives the second service request, it routes this second service request to the device 4 to be monitored having the MAC address X, in accordance with the ARP cache table. When the device 4 to be monitored receives this second service request, its sends a service response in respect of the second service request to the IP address duplication monitoring device 1.

Next, the case where duplicate IP addresses were set up will be described. For convenience in description, it will be assumed that the same IP address A was set in respect of the device 4 to be monitored and a device 5 in the same LAN. Since the ARP cache of the gateway router 3 that received the first service request was cleared, the ARP request for the IP address A is broadcast. When the device 4 to be monitored receives the ARP request, its sends its MAC address X as an ARP response to the gateway router 3. In the same way, when the device 5 in the same LAN receives the ARP request, this device also sends its MAC address Y as an ARP response to the gateway router 3.

If, of these two ARP responses, the ARP response from the device 4 to be monitored is the first to be received by the gateway router 3, the gateway router 3 stores the set of the IP address A and MAC address X in its ARP cache table and routes the first service request to the device 4 to be monitored having the MAC address X. When the device 4 to be monitored receives this first service request, it sends to the IP address duplication monitoring device 1 a service response in respect of this first service request. When, thereafter, of the two ARP responses, the ARP response from the device 5 in the same LAN is received by the gateway router 3, the gateway router 3 overwrites the MAC address X that was previously stored in the ARP cache table with the MAC address Y.

Next, when the gateway router 3 receives the second service request, it routes the second service request to the device 5 in the same LAN having the MAC address Y, in accordance with the overwritten ARP cache table. When this device 5 in the same LAN receives this second service request, it sends a service response in respect of the second service request to the IP address duplication monitoring device 1.

Due to the phenomenon of overwriting of the ARP cache table caused by the ARP responses as described above, the content of the ARP cache table is replaced for a short period. That is, when two consecutive service requests are transmitted, if duplicate IP addresses have been set, the path of the service request and service response and the content of the service response change. In this embodiment, IP address duplication is monitored by the IP address duplication monitoring device 1 utilizing this phenomenon of overwriting of the ARP cache table in sending two service requests and comparing the service responses in respect of these two service requests. Since this confirmation means for monitoring IP address duplication resides in the IP layer and above, it is transmitted through the routers; monitoring of IP address duplication can therefore be achieved from a remote location up to 256 hops, which is the theoretical upper limit set for TTL (time to live) of an IP header.

Next, a description will be given concerning the time interval for transmission of the second service request after transmission of the first service request. This time interval Tr can be set at will between the minimum value and maximum value described below.

The minimum value is determined by the time required for the ARP response to an ARP request and its processing in the gateway router 3. Although “2.3.2.2” of RFC 1122 sets the requirement of “an ARP awaiting-resolution queue of at least one packet” operation in the case of two or more packets is not specified and there is a possibility that the second and subsequent packets could be discarded. It is therefore preferable that the IP address duplication monitoring device 1 should not send the second service request until the first service request has been processed by the gateway router 3. Normally one second is suitable as the minimum value of this time interval Tr. Also, in some cases, the requests may be sent without a break, depending on the installation of the gateway router 3. In this case, the minimum value of the time interval Tr is 0 seconds.

The maximum value is determined by the clearing interval of the ARP cache in the gateway router 3. Regarding the clearing interval, this depends on the ARP installation and “2.3.2.1-(1) Timeout” of RFC 1122 merely states that this should be “of the order of minutes”. It is therefore desirable to set 1 minute as the maximum value of the time interval Tr; this should permit reliable caching.

Summarizing the above, the time interval Tr may be suitably set as 1 second=Tr<1 minute.

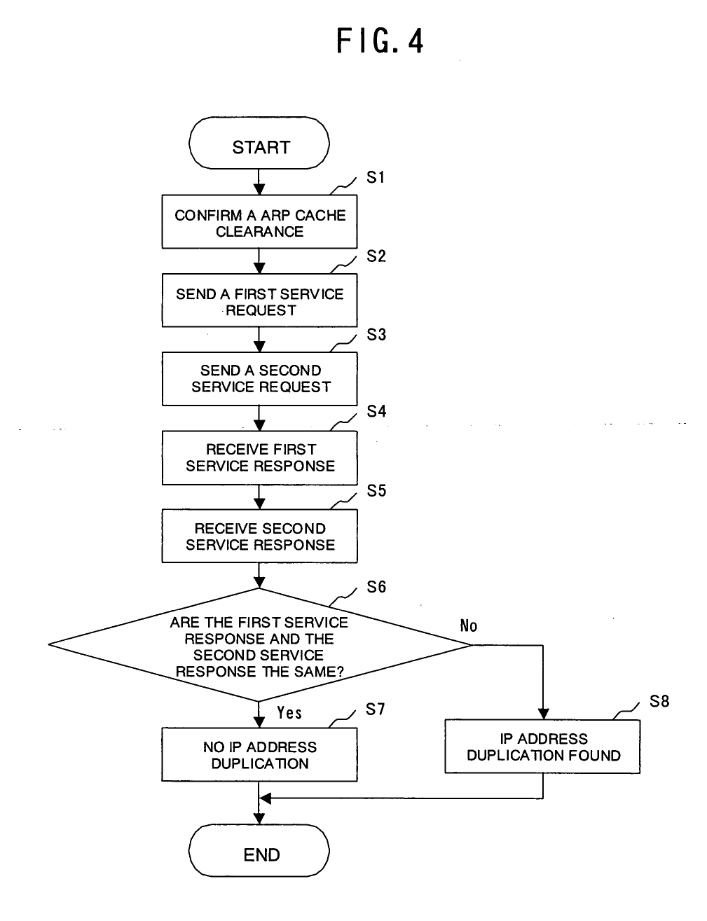

Next, the operation of an IP address duplication monitoring device according to this embodiment is described using the flow chart of FIG. 4.

Initially, the IP address duplication monitoring device 1 confirms (S1) that the ARP cache of the gateway router 3 has been cleared.

Next, the IP address duplication monitoring device 1 sends (S2) a first service request to the IP address A of the device 4 to be monitored and, after the lapse of a time interval Tr, sends (S3) a second service request to the IP address A of the device 4 to be monitored.

When the IP address duplication monitoring device 1 receives the service response in respect of the first service request, it holds (S4) this received service response as a first service response. Also, when the IP address duplication monitoring device 1 receives the service response in respect of the second service request, it holds (S5) this received service response as a second service response.

Next, the IP address duplication monitoring device 1 compares the held first service response and second service response (S6). If the compared results are the same (S6, Yes), it is judged (S7) that there is no IP address duplication and this flow is terminated. In contrast, if the compared results are different (S6, No), it is judged (S8) that there is a high probability of IP address duplication and this flow is terminated.

Next, detection of IP address duplication is described in detail. The service request utilizes the service (OSI (open systems intercommunication) reference model layer 3 and over) that is provided by the device 4 that is to be monitored, as described above. Seeing that the device 4 to be monitored is the subject of monitoring, it will usually be some sort of server and the ports of the services of this server can therefore inevitably be employed for monitoring purposes. Examples of various types of protocol constituting candidates for this use are ICMP (Internet Control Message Protocol), echo (ping), telnet, smtp (Simple Mail Transfer Protocol), pop (Post Office Protocol), snmp (Simple Network Management Protocol), ftp (File Transfer Protocol), or www (World Wide Web) (http).

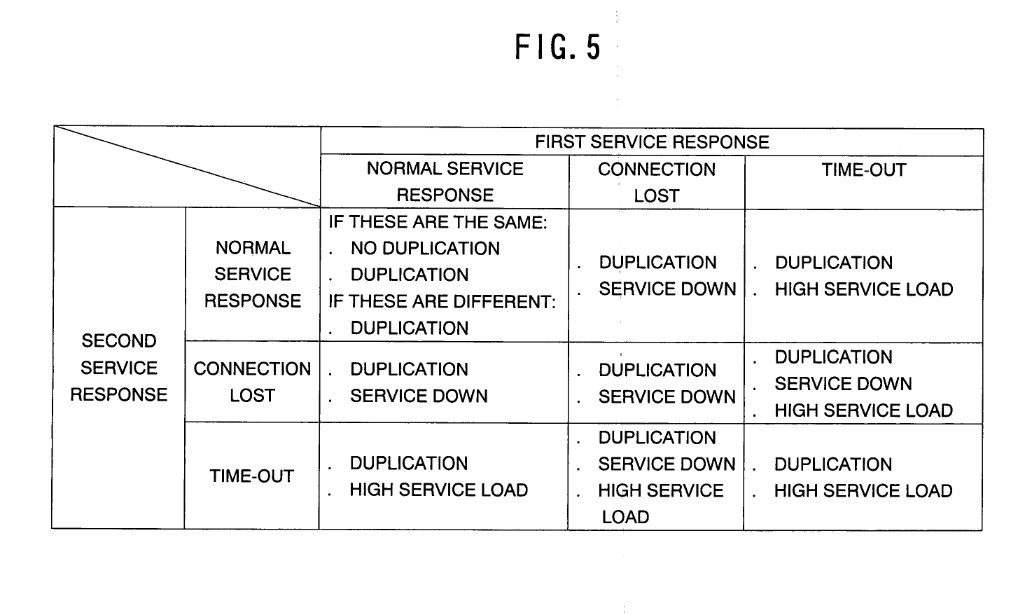

FIG. 5 is a table showing an example of monitoring decision results. This table shows combinations of two service responses in respect of two service requests and the decision results corresponding to the combinations. Example service response results in respect of a service request are a normal service response i.e. a response of normal service, or refusal of connection, or time-out.

When at least one of the two service responses is a failure to connect, a conclusion of duplication or “service down” is drawn. Also, when at least one of the two service responses is time-out, a conclusion of duplication or high service load is drawn. Since high service load or service down may be excluded by other evaluation techniques, it may be unnecessary to consider these concurrently with IP address duplication. Which of “service down”, high service load or duplication obtains can be distinguished by having the system manager perform a check to establish whether or the device is in a normal operating condition, by for example an evaluation technique using the logs of the device 4 to be monitored. If, therefore, loss of connection or time-out occurs at least once in the two service responses, duplication may be diagnosed.

In the case where both of the two service responses are normal service responses, but the two normal service responses are different, duplication is diagnosed. This is a case in which a device 5 in the same LAN as the device 4 to be monitored accidentally has the same service port open, so that the normal service responses that are returned are different. This often appears in services such as telnet that return different fixed messages for each device as a normal service response. Consequently, in this case, duplication can be reliably diagnosed.

In the case where, when both of the two service responses on normal service responses, the two normal service responses are the same, a conclusion of absence of duplication or existence of duplication is drawn. In this case, when a device 5 in the same LAN as the device 4 to be monitored accidentally has the same service port open, if the normal service response that is returned happens to be the same, the two normal service responses will be the same even in the case of duplication. Apart from ICMP echo (ping) etc, in which there is basically no difference in the normal service responses, it is possible for the same normal service response to be returned even in the case of an application such as a http, if operation is conducted with the initial set-up unaltered.

Consequently, when monitoring for IP address duplication, it is vital to choose a service whereby, even in the case of accidental duplication by a device 5 in the same LAN, such a device will not return the same normal service response. Examples of such services include telnet, which returns a normal service response including for example the OS version and kernel version, ftp, pop, dns (Domain Name System), or www top page, that return a normal service response including the FQDN (Fully Qualified Domain Name) stating for example the host name, or individual services or applications etc that can be confidently stated not to be running on other devices.

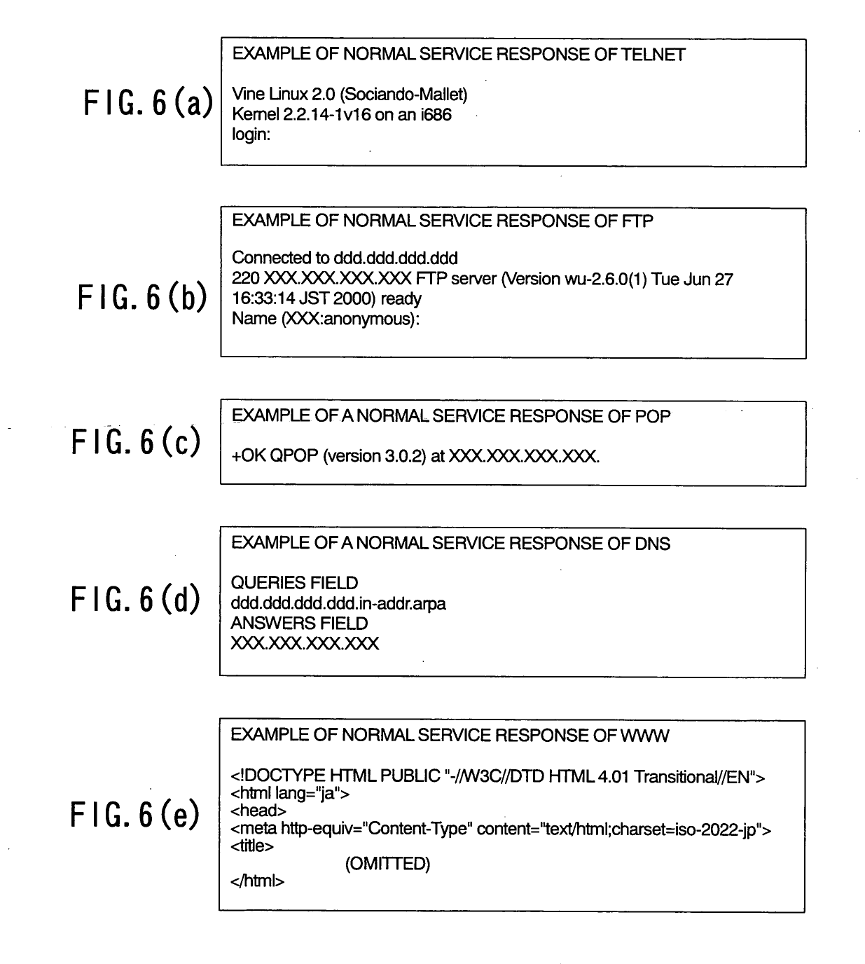

FIG. 6 is a view showing an example of normal service response for each service. In FIG. 6, ddd. ddd. ddd. ddd indicates an IP address and XXX. XXX. XXX. XXX indicates the FQDN. FIG. 6(a) is an example of a normal service response of telnet. The normal service response of telnet includes for example the OS version and kernel version. FIG. 6(b) is an example of the normal service response of ftp. FIG. 6(c) is an example of the normal service response of pop. The normal service response of ftp and the normal service response of pop include the FQDN and server version etc. The normal service response of dns includes the FQDN. FIG. 6(e) is an example of the normal service response of www. Since the server is being monitored, the www top page would not normally be expected to be used with the initial setting, so the results will be different so long as the same page is not mirrored by a device that accidentally has a duplicate IP address.

Also, in order to increase the accuracy of detection of IP address duplication, in addition, the following two decision methods may be employed in the monitoring section 13. These two decision methods are: (1) a method of deciding from a plurality of decision results obtained by periodically repeated monitoring and (2) a method of utilizing a plurality of service ports.

First of all, method (1) will be described. Method (1) utilizes the instability of service response caused by ARP responses as described above. If IP address duplication exists, even if the device 4 to be monitored is operating normally, the service response to the service request could be anything else at all apart from time-out. Accordingly, in monitoring, a plurality of sets are repeated, each set representing an operation of twice sending a service request and receiving two service responses. The monitoring section 13 collects a plurality of sets of two service responses and compares the plurality of service responses and uses the results of this comparison to make a decision as to whether or not a duplicate IP address has been set up. While it can be the that the possibility of IP address duplication is high merely from the existence of a single set of normal service response and connection failure in the sets of a plurality of service responses, if this happens a plurality of times, the conclusion may be drawn that this is extremely suspicious.

Next, method (2) will be described. In method (2), the same check is performed in respect of a plurality of service ports. Although, in this embodiment, only the HTTP port of the device 4 to be monitored was utilized, the accuracy of detection of IP address duplication can be improved by checking a plurality of ports utilizing the other service ports such as telnet and ftp of the device 4 to be monitored in the same way. That is, connection is effected with a plurality of ports on which the device 4 to be monitored having the IP address to be monitored provides services, and the service requests generated with the protocols of these services are respectively sent twice in each case to the IP address to be monitored.

The monitoring section 13 makes a decision as to whether or not a duplicate IP address has been set by comparing the sets of service responses obtained for each service, in accordance with the results of a plurality of comparisons. For example in the case where the service response obtained from HTTP is “loss of connection”, although it is difficult to judge simply from this that the HTTP service is down, if the service response in respect of other service ports was simultaneously “loss of connection”, there is a high probability of IP address duplication, since the likelihood of simultaneous cessation of a plurality of services is low. In this case also, by having the system manager check whether or not the device is in a normal operating condition by using for example the logs of the device 4 to be monitored, it is possible to distinguish between service down, high service load and duplication.

By means of method (2), it possible to increase detection accuracy of IP address duplication by excluding service down and high service load. A further improvement in accuracy of detection of IP address duplication by the monitoring section 13 can be achieved by employing the two methods, namely, method (1) and method (2) simultaneously.

It should be noted that, although HTTP was selected for the service request of the service protocol in the present embodiment, any protocol could be employed for this service request, so long as it returns a characteristic normal service response on a port that is provided by a service of the device to be monitored and includes the host name etc. Good examples are telnet, ftp, http, snmp and dns.

The device to be monitored can therefore be running any service that gives a characteristic normal response as described above. Various types of server are available that are capable of utilizing for example telnet and snmp, such as switches capable of setting for management purposes, routers, firewalls, DNS, SSL (Secure Sockets Layer) accelerators, cache servers, Web servers, load balancers, mail servers etc. However, this excludes servers that cannot be used since they are blocked by a firewall. Also, servers that have the capability of being utilized with ftp include Web servers and ftp servers. Servers that have the capability of being used with http comprise Web servers. DNS servers have the capability of being used with dns. Of these, regarding firewalls on the monitoring route, the present invention is most suitable for monitoring Web servers, since typically a web server must have the HTTP port open in view of the purpose for which it is used.

Also, IP address duplication may be generated within a network. The present invention is capable of monitoring for IP address duplication not only in the case of hubs, switching hubs or bridge layouts, but also, irrespective of the network mode, between nodes utilizing VLAN (Virtual LAN) or VPN (Virtual Private Network).

Also, if IP address duplication exists in the case of address resolution of for example an Ethernet or FDDI (Fiber Distributed Data Interface) comprising one or two layers below the IP layer in for example the OSI reference model, the present invention can be directly applied, so long as the setup is one in which the response address of the layers below the IP layer can be changed.

### INDUSTRIAL APPLICABILITY

As described above, with the present invention, monitoring for IP address duplication can be performed even in remote locations separated by several routers from the device to be monitored. Also, since the service response of a service that is conventionally provided on the device to be monitored is made use of, monitoring can be achieved without requiring any alteration of the device to be monitored. Also, there is no need to introduce a monitoring device for monitoring for IP address duplication into the same network as that of the device to be monitored. Furthermore, since it is possible to perform monitoring for IP address duplication in a plurality of networks from a single IP address duplication monitoring device, the cost of introduction and use can be made far lower than conventionally, where a monitoring device for IP address duplication monitoring is introduced into the individual networks.

1. An IP address duplication monitoring device that is capable of communication with a network having a router comprising an ARP cache in which a set comprising an IP address and a lower layer address which is an address of a lower layer than the IP layer is held for a fixed period and that performs monitoring of IP address duplication for a device to be monitored that is connected with said network; comprising:
a service request issuing section that sends a plurality of service requests to said device to be monitored;
a service response analysis section that receives service responses obtained as a result of said service requests; and
a monitoring section that generates an instruction for a service request to said service request issuing section at prescribed time intervals, that compares said plurality of service responses obtained from said service response analysis section and that makes a decision as to the existence of IP address duplication based on the results of this comparison.

2. The IP address duplication monitoring device according to claim 1 characterized in that said monitoring section generates an instruction for a first service request to said service request issuing section and, after a prescribed time interval, generates an instruction for a second service request, and compares the first service response obtained in respect of the first service request instruction with the second service response obtained in respect of the second service request instruction.

3. The IP address duplication monitoring device according to claim 2 characterized in that said lower layer address is a MAC address.

4. The IP address duplication monitoring device according to claim 3 characterized in that said monitoring section generates an instruction for a service request in respect of a service that returns a service response that is specific to said device to be monitored.

5. The IP address duplication monitoring device according to claim 4 characterized in that the service that returns a service response that is specific to the device to be monitored is any of telnet that returns a service response including the OS version or kernel version, ftp, pop, or dns that returns a service response including FQDN, a service or application that is unique to said device to be monitored and that is not provided by the other devices in said LAN, or www top page.

6. The IP address duplication monitoring device according to claim 4 characterized in that said monitoring section generates an instruction for said first service request after confirming that the ARP cache of said router has been cleared.

7. The IP address duplication monitoring device according to claim 6 characterized in that said time interval is set in a range whose minimum value is the time period for said router to receive said first service request, send an ARP request and, receive the ARP response, to perform routing of said service request, and whose maximum value is the time period required for clearing of the ARP cache by said router.

8. The IP address duplication monitoring device according to claim 7 characterized in that said monitoring section judges that no IP address duplication exists if said first service response is a normal service response and said second service response is a normal service response and the contents of said first service response and said second service response are the same.

9. The IP address duplication monitoring device according to claim 8 characterized in that, if said device to be monitored provides a plurality of services, said monitoring section generates an instruction for said first service request corresponding to each of said plurality of services and generates an instruction for said second service request corresponding to each of said plurality of services, performs a comparison of the service response obtained for each service and makes a decision as to the existence of IP address duplication based on the results of this comparison.

10. The IP address duplication monitoring device according to claim 8 characterized in that said monitoring section repeats a set of said instruction to request a first service and said instruction to request a second service a plurality of times, compares the plurality of service responses obtained and makes a decision as to the existence of IP address duplication based on the results of this comparison.

11. The IP address duplication monitoring device according to claim 9 characterized in that said monitoring section further repeats a set of said instruction to request a first service and said instruction to request a second service a plurality of times, performs a comparison of the plurality of service responses obtained and makes a decision as to the existence of IP address duplication based on the results of this comparison.

12. An IP address duplication monitoring method of performing monitoring for IP address duplication from outside of a network for a device to be monitored that is connected with said network having a router comprising an ARP cache in which a set comprising an IP address and a lower layer address which is an address of a lower layer than the IP layer is held for a fixed period, comprising:
giving an instruction for a service request to the service request issuing section at prescribed time intervals;
sending a service request to said device to be monitored in accordance with said service request instructions;
receiving the service response obtained as a result of said service requests; and
comparing said plurality of service responses received and making a decision as to the existence of IP address duplication based on the results of this comparison.

13. An IP address duplication monitoring program which is stored on a computer readable medium, for causing a computer to execute monitoring of IP address duplication from outside of a network, for a device to be monitored that is connected with said network having a router comprising an ARP cache in which a set comprising an IP address and a lower layer address which is an address of a lower layer than the IP layer is held for a fixed period, the program being characterized in that it causes the computer to execute:
giving an instruction for a service request to the service request issuing section at prescribed time intervals;
sending a service request to said device to be monitored in accordance with said service request instructions;
receiving the service response obtained as a result of said service requests; and
comparing said plurality of service responses received and making a decision as to the existence of IP address duplication based on the results of this comparison.
